(19) United States
(12) Patent Application Publication
(10) Pub. No.: US 2023/0137134 A1
(43) Pub. Date: May 4, 2023

(54) ROTATING ELECTRICAL MACHINE AND DRIVE DEVICE

(71) Applicant: NIDEC CORPORATION, Kyoto (JP)

(72) Inventors: Keisuke NAKATA, Kyoto (JP); Yuki ISHIKAWA, Kyoto (JP); Sota DOI, Kyoto (JP); Kouhei OBA, Kyoto (JP)

(21) Appl. No.: 17/969,690

(22) Filed: Oct. 20, 2022

(30) Foreign Application Priority Data
Oct. 29, 2021 (JP) 2021-177840

(51) Int. Cl. H02K 5/173; H02K 5/14; H02K 7/116

(52) U.S. Cl. CPC H02K 5/1735; H02K 5/14; H02K 7/116

(57) ABSTRACT

A rotating electrical machine includes a rotor, a stator, a housing, a bearing, an electricity removal device in electrical contact with a shaft and the housing, a nozzle supplying a fluid into the shaft, and a cover covering a part of the device. The shaft includes a hollow first member, a hollow second member coupled to a first side of the first member, and a channel communicating the inside and outside of the shaft. A part of the nozzle is inserted into the second member from an opening end. The housing has a peripheral wall surrounding the opening end. The bearing is held in the peripheral wall and is positioned away on the second side of the device. The cover is axially between the bearing and the device. The channel is opened in a portion positioned on the second side relative to the cover inside the peripheral wall.

### CROSS-REFERENCE TO RELATED APPLICATIONS

The present invention claims priority under 35 U.S.C. § 119 to Japanese Patent Application No. 2021-177840 filed on Oct. 29, 2021, the entire content of which is incorporated herein by reference.

### FIELD OF THE INVENTION

The present invention relates to a rotating electrical machine and a drive device.

### BACKGROUND

There is known a charge dissipation device that dissipates charges from a shaft of a rotating electrical machine. For example, a current shunt ring having a conductive segment in contact with the shaft is conventionally known.

In a rotating electrical machine including the charge dissipation device as described above, there is a case where a fluid is supplied to a rotor, a stator, and the like for the purpose of cooling, for example. In this case, when the fluid is applied to the charge dissipation device, the conductivity of the charge dissipation device is reduced, and the charge is hardly dissipated in some cases.

### SUMMARY

One aspect of an exemplary rotating electrical machine of the present invention includes: a rotor having a hollow shaft rotatable about a central axis; a stator opposing the rotor with a gap interposed therebetween; a housing internally accommodating the rotor and the stator; a bearing rotatably supporting the shaft; an electricity removal device fixed to the housing and in electrical contact with the shaft and the housing; a nozzle member that supplies a fluid to an inside of the shaft; and a cover member that covers at least a part of the electricity removal device. The shaft includes a hollow first shaft member, a hollow second shaft member that is a separate body from the first shaft member and is coupled to a first axial side of the first shaft member, and a connection channel portion that allows an inside of the shaft and an outside of the shaft to communicate each other. The second shaft member has an opening end portion that opens on a first axial side. At least a part of the nozzle member is inserted into the second shaft member from the opening end portion. The housing has a peripheral wall portion surrounding the opening end portion. The bearing is held in the peripheral wall portion and is positioned away on the second axial side of the electricity removal device. The cover member is positioned axially between the bearing and the electricity removal device. The connection channel portion is open in a portion positioned on a second axial side relative to the cover member inside the peripheral wall portion.

One aspect of an exemplary drive device of the present invention includes the above rotating electrical machine and a gear mechanism connected to the rotating electrical machine.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is an outline configuration diagram schematically illustrating a drive device of a first embodiment;

FIG. 2 is a cross-sectional view illustrating a part of a rotating electrical machine of the first embodiment;

FIG. 3 is an exploded perspective view illustrating a second shaft member, a cover member, an electricity removal device, and a nozzle member of the first embodiment;

FIG. 4 is an exploded perspective view illustrating the second shaft member, the cover member, the electricity removal device, and the nozzle member of the first embodiment, and is a view of each member viewed from an angle different from that in FIG. 3;

FIG. 5 is a cross-sectional view illustrating a flow of oil supplied from the nozzle member to an inside of the shaft in the first embodiment;

FIG. 6 is a cross-sectional view illustrating a part of a rotating electrical machine of a second embodiment;

and

FIG. 7 is a cross-sectional view illustrating a part of a rotating electrical machine of a third embodiment.

### DETAILED DESCRIPTION

The following description will be made with a vertical direction being defined on the basis of positional relationships in the case where a drive device of embodiments is equipped in a vehicle positioned on a horizontal road surface. That is, it is sufficient that the relative positional relationships regarding the vertical direction described in the following embodiments are satisfied at least in the case where the drive device is equipped in the vehicle positioned on the horizontal road surface.

In the drawings, an XYZ coordinate system is illustrated appropriately as a three-dimensional orthogonal coordinate system. In the XYZ coordinate system, a Z-axis direction corresponds to the vertical direction. An arrow in the Z-axis is directed toward a side (+Z side) that is an upper side in the vertical direction, and a side (−Z side) opposite to the side toward which the arrow in the Z-axis is directed is a lower side in the vertical direction. In the following description, the upper side and the lower side in the vertical direction will be referred to simply as the “upper side” and the “lower side”, respectively. An X-axis direction is orthogonal to the Z-axis direction and corresponds to a front-rear direction of the vehicle equipped with the drive device. In the following embodiments, a side (+X side) toward which an arrow in the X-axis is directed is a front side in the vehicle, and a side (−X side) opposite to the side toward which the arrow in the X-axis is directed is a rear side in the vehicle. A Y-axis direction is a direction orthogonal to both the X-axis direction and the Z-axis direction and corresponds to a left-right direction of the vehicle, i.e., a vehicle lateral direction. In the following embodiments, a side (+Y side) toward which an arrow in the Y-axis is directed is a left side in the vehicle, and a side (−Y side) opposite to the side toward which the arrow in the Y-axis is directed is a right side in the vehicle. Each of the front-rear direction and the left-right direction is a horizontal direction orthogonal to the vertical direction.

A positional relationship in the front-rear direction is not limited to the positional relationship of the following embodiments. The side (+X side) toward which the arrow in the X-axis is directed may be the rear side in the vehicle, and the side (−X side) opposite to the side toward which the arrow in the X-axis is directed may be the front side in the vehicle. In this case, the side (+Y side) toward which the arrow in the Y-axis is directed is the right side in the vehicle, and the side (−Y side) opposite to the side toward which the arrow in the Y-axis is directed is the left side in the vehicle. In the present description, a “parallel direction” includes a substantially parallel direction, and an “orthogonal direction” includes a substantially orthogonal direction.

A central axis J illustrated in the drawings as appropriate is a virtual axis extending in a direction intersecting the vertical direction. More specifically, the central axis J extends in the Y-axis direction orthogonal to the vertical direction, i.e., in the left-right direction of the vehicle. In description below, unless otherwise particularly stated, a direction parallel to the central axis J is simply referred to as “axial direction”, a radial direction about the central axis J is simply referred to as “radial direction”, and a circumferential direction about the central axis J, i.e., a direction about the central axis J is simply referred to as “circumferential direction”. In the following embodiments, the right side (−Y side) is referred to as “first axial side”, and the left side (+Y side) is referred to as “second axial side”.

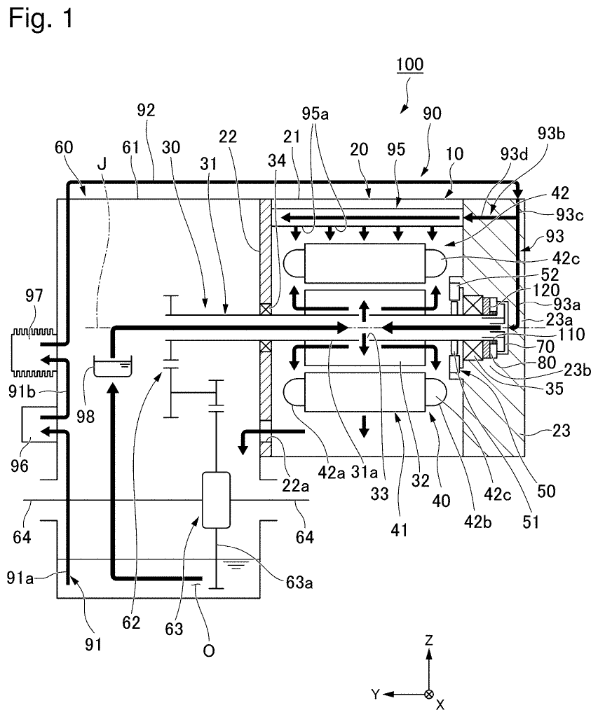

A drive device 100 of the present embodiment illustrated in FIG. 1 is a drive device that is equipped in a vehicle and rotates an axle 64. The vehicle equipped with the drive device 100 is a vehicle including a motor as a power source, such as a hybrid vehicle (HEV), a plug-in hybrid vehicle (PHV), or an electric vehicle (EV). As illustrated in FIG. 1, the drive device 100 includes a rotating electrical machine 10 and a gear mechanism 60. The gear mechanism 60 is connected to the rotating electrical machine 10 and transmits the rotation of the rotating electrical machine 10, that is, the rotation of a rotor 30 described later to the axle 64 of the vehicle. The gear mechanism 60 of the present embodiment includes a gear housing 61, a speed reducer 62 connected to the rotating electrical machine 10, and a differential gear 63 connected to the speed reducer 62.

The gear housing 61 internally accommodates the speed reducer 62, the differential gear 63, and oil O. The oil O is stored in a lower region in the gear housing 61. The oil O circulates in a refrigerant channel portion 90 described later. The oil O is used as a refrigerant for cooling the rotating electrical machine 10. The oil O is also used as lubricating oil for the speed reducer 62 and the differential gear 63. As the oil O, for example, an oil equivalent to an automatic transmission fluid (ATF) having a relatively low viscosity is preferably used to function as a refrigerant and lubricating oil.

The differential gear 63 includes a ring gear 63a. Torque output from the rotating electrical machine 10 is transmitted the ring gear 63a through the speed reducer 62. The ring gear 63a has a lower end portion immersed in the oil O stored in the gear housing 61. When the ring gear 63a rotates, the oil O is scraped up. The oil O scraped up is supplied to, for example, the speed reducer 62 and the differential gear 63 as lubricating oil.

The rotating electrical machine 10 is a portion that drives the drive device 100. The rotating electrical machine 10 is positioned, for example, on a first axial side (−Y side) of the gear mechanism 60. In the present embodiment, the rotating electrical machine 10 is a motor. The rotating electrical machine 10 includes a motor housing 20, the rotor 30 having a shaft 31, bearings 34 and 35 that rotatably support the rotor 30, a stator 40, a resolver 50, a nozzle member 70, an electricity removal device 80, and a cover member 120. The bearings 34 and 35 are each a ball bearing, for example.

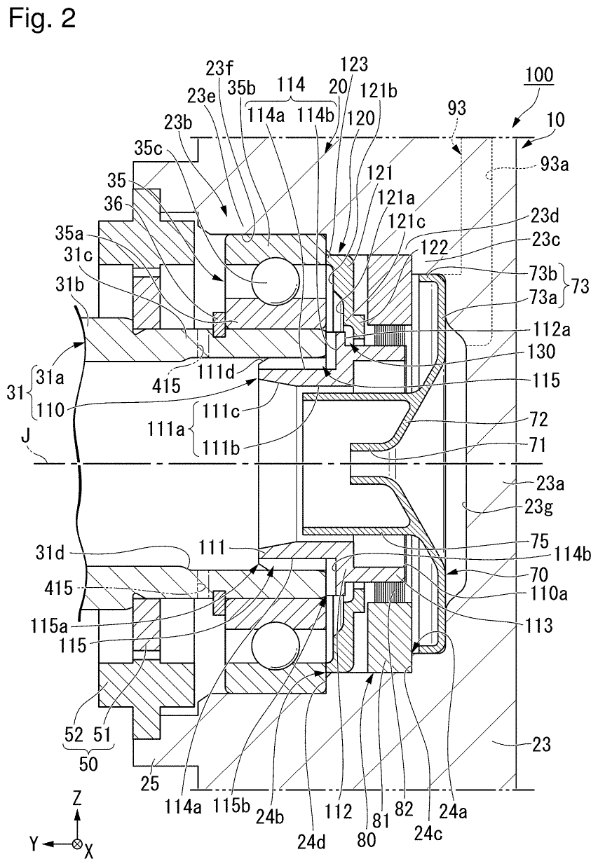

In the present embodiment, the bearings 34 and 35 are ceramic ball bearings. The bearing 34 rotatably supports a portion of the shaft 31 positioned on the second axial side (+Y side) relative to the stator 40. The bearing 35 rotatably supports a portion of the shaft 31 positioned on the first axial side (−Y side) relative to the stator 40. As illustrated in FIG. 2, the bearing 35 includes an inner ring 35a having an annular shape about the central axis J, an outer ring 35b having an annular shape about the central axis J and positioned radially outside the inner ring 35a, and a plurality of balls 35c positioned radially between the inner ring 35a and the outer ring 35b. The configuration of the bearing 34 is similar to the configuration of the bearing 35.

The motor housing 20 is a housing that internally accommodates the rotor 30 and the stator 40. The motor housing 20 communicates with the gear housing 61 on the first axial side (−Y side). The motor housing 20 has a body portion 21, a partition wall portion 22, and a lid portion 23. The body portion 21 and the partition wall portion 22 are each, for example, a part of an identical single member. The lid portion 23 is separate from, for example, the body portion 21 and the partition wall portion 22.

The body portion 21 is in a tubular shape that surrounds the central axis J and opens on the first axial side (−Y side). The partition wall portion 22 communicates with an end portion of the body portion 21 on the second axial side (+Y side). The partition wall portion 22 axially partitions the inside of the motor housing 20 and the inside of the gear housing 61. The partition wall portion 22 has a partition wall opening 22a that allows the inside of the motor housing 20 and the inside of the gear housing 61 to communicate with each other. The partition wall portion 22 holds the bearing 34. The lid portion 23 is fixed to an end portion of the body portion 21 on the first axial side. The lid portion 23 closes an opening of the body portion 21 on the first axial side. The lid portion 23 holds the bearing 35.

As illustrated in FIG. 2, the lid portion 23 has a hole portion 23f recessed from a surface on the second axial side (+Y side) to the first axial side (−Y side) of the lid portion 23. The hole portion 23f is a hole that has a bottom portion on the first axial side and opens on the second axial side. In the present embodiment, the hole portion 23f is a circular hole about the central axis J. Providing the hole portion 23f provides the lid portion 23 with a bottom wall portion 23a and a peripheral wall portion 23b. That is, the motor housing 20 includes the bottom wall portion 23a and the peripheral wall portion 23b.

The bottom wall portion 23a is the bottom portion of the hole portion 23f. The bottom wall portion 23a is positioned on the first axial side (−Y side) of an opening end portion 110a of the shaft 31. A surface of the bottom wall portion 23a on the second axial side (+Y side) is provided with a recess portion 23g recessed on the first axial side. When viewed axially, the inner edge of the recess portion 23g has a circular shape about the central axis J. The peripheral wall portion 23b protrudes from a radially outer peripheral edge portion of the bottom wall portion 23a on the second axial side (+Y side). The peripheral wall portion 23b surrounds the opening end portion 110a of the shaft 31. The peripheral wall portion 23b has an inner peripheral surface that is an inner peripheral surface of the hole portion 23f. In the present embodiment, the inner peripheral surface of the peripheral wall portion 23b has a cylindrical shape about the central axis J.

The peripheral wall portion 23b includes a first wall portion 23c, a second wall portion 23d, and a third wall portion 23e. The first wall portion 23c is a portion communicating with a radially outer peripheral edge portion of the bottom wall portion 23a. The second wall portion 23d communicates with the first wall portion 23c on the second axial side (+Y side). The second wall portion 23d has a larger inner diameter than that of the first wall portion 23c. The second wall portion 23d has a larger axial dimension than that of the first wall portion 23c. The third wall portion 23e communicates with the second wall portion 23d on the second axial side. The third wall portion 23e has a larger inner diameter than that of the second wall portion 23d. The third wall portion 23e has a larger axial dimension than that of the second wall portion 23d. The bearing 35 is held on the radially inner side the third wall portion 23e. That is, the bearing 35 is held in the peripheral wall portion 23b. The outer ring 35b of the bearing 35 is fitted to the radially inner side of the third wall portion 23e.

In the present embodiment, the inner peripheral surface of the peripheral wall portion 23b has a first stepped portion 24a and a second stepped portion 24b. The first stepped portion 24a is a step provided axially between an inner peripheral surface of the first wall portion 23c and an inner peripheral surface of the second wall portion 23d. The first stepped portion 24a has a first stepped surface 24c facing the second axial side (+Y side). The first stepped surface 24c has an annular shape about the central axis J. The first stepped surface 24c is a flat surface orthogonal to the axial direction. The second stepped portion 24b is a step provided axially between an inner peripheral surface of the second wall portion 23d and an inner peripheral surface of the third wall portion 23e. The second stepped portion 24b has a second stepped surface 24d facing the second axial side. The second stepped surface 24d has an annular shape about the central axis J. The second stepped surface 24d is a flat surface orthogonal to the axial direction. The bearing 35 held in the third wall portion 23e is in contact with the second stepped surface 24d. Therefore, the bearing 35 can be suitably positioned axially with respect to the motor housing 20. More specifically, the outer ring 35b of the bearing 35 is in contact with the second stepped surface 24d from the second axial side.

A surface of the lid portion 23 on the second axial side (+Y side) is provided with a resolver holding portion 25. In the present embodiment, the resolver holding portion 25 is provided on the peripheral edge portion of the hole portion 23f of the surface of the lid portion 23 on the second axial side. The resolver holding portion 25 extends in the circumferential direction and surrounds the shaft 31.

As illustrated in FIG. 1, the rotor 30 includes the shaft 31 and a rotor body 32. Although not illustrated, the rotor body 32 includes a rotor core, and a rotor magnet fixed to the rotor core. The torque of the rotor 30 is transmitted to the gear mechanism 60.

The shaft 31 is rotatable about the central axis J. The shaft 31 is rotatably supported by the bearings 34 and 35. The shaft 31 is a hollow shaft. The shaft 31 has a cylindrical shape that extends axially about the central axis J. The shaft 31 is provided with a hole portion 33 that allows the inside of the shaft 31 and an outside of the shaft 31 to communicate with each other. The shaft 31 extends across the inside of the motor housing 20 and the inside of the gear housing 61. The shaft 31 has an end portion on the second axial side (+Y side) that protrudes into the inside of the gear housing 61. The shaft 31 is connected at the end portion on the second axial side with the speed reducer 62.

As illustrated in FIG. 2, the shaft 31 includes a hollow first shaft member 31a and a hollow second shaft member 110. The first shaft member 31a has a cylindrical shape extending axially about the central axis J. The first shaft member 31a is open on both axial sides. As illustrated in FIG. 1, the first shaft member 31a extends across the inside of the motor housing 20 and the inside of the gear housing 61. The first shaft member 31a is rotatably supported by the bearings 34 and 35. For example, the first shaft member 31a may be configured by axially coupling a motor shaft positioned in the motor housing 20 and a gear shaft positioned in the gear housing 61.

As illustrated in FIG. 2, the first shaft member 31a includes a large-diameter portion 31b and a small-diameter portion 31c. The small-diameter portion 31c communicates with the first axial side (−Y side) of the large-diameter portion 31b. The outer diameter of the small-diameter portion 31c is smaller than the outer diameter of the large-diameter portion 31b. The axial dimension of the small-diameter portion 31c is smaller than the axial dimension of the large-diameter portion 31b. The end portion on the first axial side of the small-diameter portion 31c is an end portion on the first axial side of the first shaft member 31a. A stepped portion having a stepped surface facing the first axial side (−Y side) is provided between an outer peripheral surface of the large-diameter portion 31b and an outer peripheral surface of the small-diameter portion 31c.

A portion on the first axial side (−Y side) of the small-diameter portion 31c is positioned radially inside the peripheral wall portion 23b. More specifically, the portion on the first axial side of the small-diameter portion 31c is positioned radially inside the third wall portion 23e. The outer peripheral surface of the small-diameter portion 31c is disposed radially inward away from the inner peripheral surface of the peripheral wall portion 23b. The inner ring 35a of the bearing 35 is fixed to an outer peripheral surface of the small-diameter portion 31c. In the present embodiment, the axial position at the end portion on the first axial side of the small-diameter portion 31c is the same as the axial position at the end portion on the first axial side of the bearing 35. A stop ring 36 is attached to the outer peripheral surface of the small-diameter portion 31c. The stop ring 36 is disposed to oppose the second axial side of the inner ring 35a of the bearing 35.

A fourth inclined surface 31d is provided on the inner peripheral surface of the first shaft member 31a. The fourth inclined surface 31d is positioned radially inward toward the second axial side (+Y side). In the present embodiment, the fourth inclined surface 31d has an annular shape about the central axis J. The fourth inclined surface 31d is a tapered surface whose inner diameter decreases toward the second axial side. The fourth inclined surface 31d is provided on the inner peripheral surface of the small-diameter portion 31c. More specifically, the fourth inclined surface 31d is provided on the small-diameter portion 31c on the inner peripheral surface of a portion of positioned on the second axial side relative to the portion supported by the bearing 35. An inner diameter of a portion of the first shaft member 31a positioned on the first axial side (−Y side) relative to the fourth inclined surface 31d is larger than an inner diameter of a portion of the first shaft member 31a positioned on the second axial side relative to the fourth inclined surface 31d.

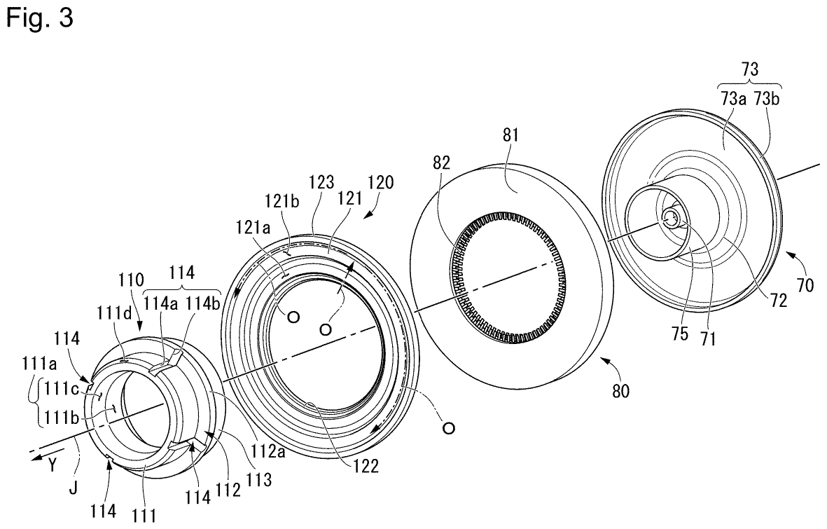

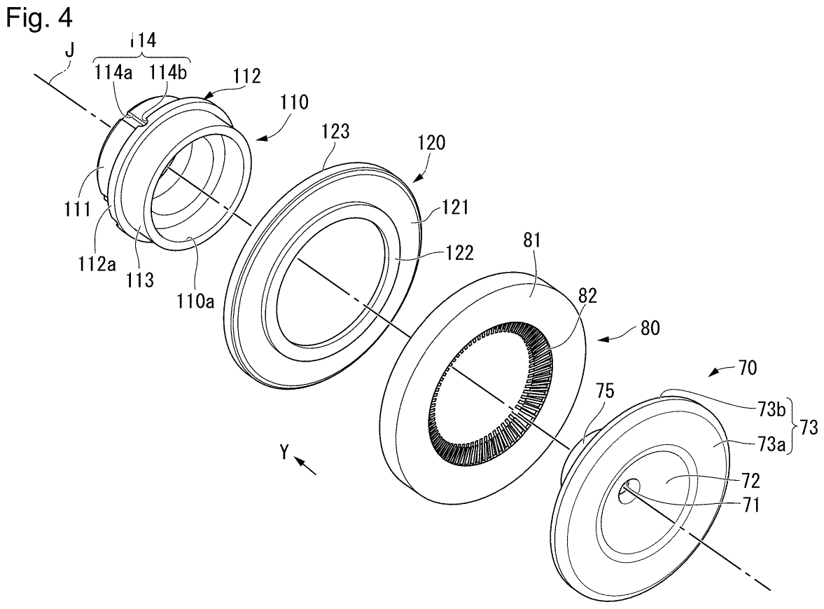

The second shaft member 110 is a separate body from the first shaft member 31a. The second shaft member 110 is coupled to the first axial side (−Y side) of the first shaft member 31a. As illustrated in FIGS. 3 and 4, the second shaft member 110 has a cylindrical shape extending axially about the central axis J. The second shaft member 110 is open on both axial sides. The end portion on the first axial side of the second shaft member 110 is an end portion on the first axial side of the shaft 31.

As illustrated in FIG. 2, the second shaft member 110 is positioned inside the motor housing 20. The second shaft member 110 is positioned radially inside the peripheral wall portion 23b. The axial dimension of the second shaft member 110 is smaller than the axial dimension of the first shaft member 31a. The second shaft member 110 has an opening end portion 110a that opens on the first axial side (−Y side). The opening end portion 110a is an end portion on the first axial side of the second shaft member 110. The opening end portion 110a is positioned radially inside the peripheral wall portion 23b. In the present embodiment, the opening end portion 110a is positioned radially inside the second wall portion 23d. The opening end portion 110a is disposed away from the bottom wall portion 23a on the second axial side (+Y side). The second shaft member 110 includes a fit tube portion 111, a flange portion 112, and a contacted tube portion 113.

The fit tube portion 111 has a cylindrical shape that opens on the second axial side (+Y side) about the central axis J. The end portion on the second axial side of the fit tube portion 111 is an end portion on the second axial side of the second shaft member 110. The fit tube portion 111 is fitted inside the first shaft member 31a. More specifically, the fit tube portion 111 is press-fitted into the end portion on the first axial side (−Y side) of the small-diameter portion 31c. Due to this, the second shaft member 110 is fixed to the first shaft member 31a. The end portion on the second axial side of the fit tube portion 111 is positioned on the second axial side relative to the end portion on the first axial side of the bearing 35, and is positioned on the first axial side relative to the end portion on the second axial side of the bearing 35.

An inner peripheral surface 111a of the fit tube portion 111 has a cylindrical surface 111b and a first inclined surface 111c. That is, the inner peripheral surface of the second shaft member 110 has the cylindrical surface 111b and the first inclined surface 111c. The cylindrical surface 111b is a portion on the first axial side (−Y side) of the inner peripheral surface 111a. The end portion on the first axial side of the cylindrical surface 111b is an end portion on the first axial side of the inner peripheral surface 111a. The cylindrical surface 111b is a surface in a cylindrical shape having a uniform inner diameter over the entire axial direction about the central axis J.

The first inclined surface 111c is a portion on the second axial side (+Y side) of the inner peripheral surface 111a. The first inclined surface 111c communicates with the second axial side of the cylindrical surface 111b. The end portion on the second axial side of the first inclined surface 111c is an end portion on the second axial side of the inner peripheral surface 111a. The first inclined surface 111c is positioned radially outward toward the second axial side. The first inclined surface 111c is a cylindrical surface whose inner diameter increases toward the second axial side about the central axis J. The shape of the first inclined surface 111c is similar to the outer peripheral surface of a truncated cone whose outer diameter increases toward the second axial side.

The outer peripheral surface at an end portion on the second axial side (+Y side) of the fit tube portion 111 is a fifth inclined surface 111d. The fifth inclined surface 111d is positioned radially inward toward the second axial side. The fifth inclined surface 111d is a cylindrical surface whose outer diameter decreases toward the second axial side about the central axis J. The shape of the fifth inclined surface 111d is similar to the outer peripheral surface of a truncated cone whose outer diameter decreases toward the second axial side. Since the fifth inclined surface 111d is provided, the outer diameter at the end portion on the second axial side of the fit tube portion 111 decreases toward the second axial side.

As illustrated in FIG. 3, the flange portion 112 protrudes radially outward from the fit tube portion 111. In the present embodiment, the flange portion 112 protrudes radially outward from an end portion on the first axial side (−Y side) of the fit tube portion 111. The flange portion 112 has an annular shape about the central axis J. As illustrated in FIG. 2, the flange portion 112 is disposed to oppose first axial side of the first shaft member 31a. In the present embodiment, the flange portion 112 is in contact with the end portion on the first axial side of the first shaft member 31a. Due to this, the second shaft member 110 is positioned axially with respect to the first shaft member 31a. An end portion on the radially outside of the flange portion 112 is positioned slightly radially inside relative to the outer peripheral surface of the end portion on the first axial side of the first shaft member 31a.

The radially outer portion of the flange portion 112 is a first opposing portion 112a disposed to oppose the cover member 120 with a gap in the axial direction. That is, the second shaft member 110 has the first opposing portion 112a. In the present embodiment, the flange portion 112 has the first opposing portion 112a. The first opposing portion 112a is a portion of the flange portion 112 that protrudes on the radially outside relative to the contacted tube portion 113. In the present embodiment, the first opposing portion 112a is positioned on the second axial side (+Y side) of the cover member 120.

As illustrated in FIG. 4, the contacted tube portion 113 has a cylindrical shape that opens on the first axial side (−Y side) about the central axis J. The end portion on the first axial side of the contacted tube portion 113 is an end portion on the first axial side of the second shaft member 110 and is the opening end portion 110a. The contacted tube portion 113 extends on the first axial side from the flange portion 112. The outer peripheral surface of the contacted tube portion 113 is positioned radially inside relative to the end portion on the radially outside of the flange portion 112. As illustrated in FIG. 2, the inside of the contacted tube portion 113 communicates with the first axial side of the inside of the fit tube portion 111. The outer diameter of the contacted tube portion 113 is larger than the outer diameter of the fit tube portion 111. The inner diameter of the contacted tube portion 113 is larger than the inner diameter of the fit tube portion 111. A brush portion 82 described later of the electricity removal device 80 is in contact with the outer peripheral surface of the contacted tube portion 113.

As illustrated in FIG. 3, the second shaft member 110 has a groove 114. A plurality of grooves 114 are provided at intervals in the circumferential direction. The plurality of grooves 114 are arranged at equal intervals over the entire circumference along the circumferential direction. In the present embodiment, four of the grooves 114 are provided. Each of the grooves 114 has a first groove 114a and a second groove 114b.

The first groove 114a is provided on the outer peripheral surface of the fit tube portion 111. The first groove 114a is recessed radially inward from the outer peripheral surface of the fit tube portion 111. The first groove 114a extends in the axial direction. The first groove 114a extends from the end portion on the second axial side (+Y side) of the fit tube portion 111 to a portion of the outer peripheral surface of the fit tube portion 111 where the flange portion 112 is communicated. The first groove 114a is open on the second axial side. In a cross section orthogonal to the axial direction in which the first groove 114a extends, the shape of the inside of the first groove 114a is, for example, a rectangular shape.

The second groove 114b is provided on a surface on the second axial side (+Y side) of the flange portion 112. The second groove 114b is recessed from the surface on the second axial side of the flange portion 112 to the first axial side (−Y side). The second groove 114b extends radially outward from an end portion on the first axial side of the first groove 114a. The second groove 114b extends from the end portion of the radially inside of the flange portion 112 to the end portion on the radially outside of the flange portion 112. The second groove 114b is open radially outward. In the cross section orthogonal to the radial direction in which the second groove 114b extends, the shape of the inside of the second groove 114b is, for example, a semicircular shape protruding to the first axial side.

As illustrated in FIG. 2, the shaft 31 includes a connection channel portion 115 that allows the inside of the shaft 31 and the outside of the shaft 31 to communicate with each other. In the present embodiment, at least a part of the connection channel portion 115 is provided in the second shaft member 110. The connection channel portion 115 is provided between the first shaft member 31a and the second shaft member 110. In the present embodiment, the connection channel portion 115 is formed by closing the opening portion on the radially outside of the first groove 114a by the inner peripheral surface of the first shaft member 31a, and closing the opening portion on the second axial side (+Y side) of the second groove 114b by the end surface on the first axial side (−Y side) of the first shaft member 31a. The inside of the connection channel portion 115 includes the inside of the first groove 114a and the inside of the second groove 114b.

The connection channel portion 115 has a first opening portion 115a that opens on the second axial side through an opening portion on the second axial side (+Y side) of the first groove 114a. The first opening portion 115a is open to the inside of the shaft 31. In the present embodiment, the first opening portion 115a is open to the inside of the first shaft member 31a of the inside of the shaft 31. The connection channel portion 115 has a second opening portion 115b that opens radially outward through an opening portion on the radially outside of the second groove 114b. The second opening portion 115b is open to the outside of the shaft 31. The second opening portion 115b is open in a portion positioned on the second axial side relative to the cover member 120 of the inside of the peripheral wall portion 23b. In the present embodiment, the second opening portion 115b is open in a portion of an inside of the peripheral wall portion 23b positioned axially between the bearing 35 and the cover member 120. More specifically, the second opening portion 115b is open in a portion of an inside of the peripheral wall portion 23b positioned axially between the inner ring 35a of the bearing 35 and the radially inner portion of the cover member 120. The second opening portion 115b is open toward a guide wall portion 123 described later.

As illustrated in FIG. 1, the stator 40 opposes the rotor 30 across a gap in the radial direction. More specifically, the stator 40 is positioned radially outward of the rotor 30. The stator 40 is fixed inside the motor housing 20. The stator 40 includes a stator core 41 and a coil assembly 42.

The stator core 41 has an annular shape surrounding the central axis J of the rotating electrical machine 10. The stator core 41 is positioned radially outside the rotor 30. The stator core 41 surrounds the rotor 30. The stator core 41 is composed of, for example, a plurality of plate members such as electromagnetic steel plates stacked in the axial direction. Although not illustrated, the stator core 41 includes a core back in a cylindrical shape extending axially, and a plurality of teeth extending to a radial inside from the core back.

The coil assembly 42 includes a plurality of coils 42c attached to the stator core 41 along the circumferential direction. The plurality of coils 42c are mounted on the respective teeth of the stator core 41 through insulators (not illustrated). The coil assembly 42 includes coil ends 42a and 42b that protrude axially from the stator core 41.

The resolver 50 can detect rotation of the rotor 30. The resolver 50 is accommodated inside the motor housing 20. The resolver 50 includes a resolver rotor 51 and a resolver stator 52. The resolver rotor 51 is fixed to the shaft 31. The resolver rotor 51 is in an annular shape surrounding the shaft 31. In the present embodiment, the resolver rotor 51 has an annular shape about the central axis J. As illustrated in FIG. 2, in the present embodiment, the resolver rotor 51 surrounds an end portion on the second axial side (+Y side) of the small-diameter portion 31c. The resolver rotor 51 has a plate shape whose plate surface faces the axial direction. The surface on the second axial side of the resolver rotor 51 is in contact with a stepped surface of the stepped portion provided axially between the large-diameter portion 31b and the small-diameter portion 31c. The resolver rotor 51 protrudes radially outward relative to the outer peripheral surface of the large-diameter portion 31b. The resolver rotor 51 is disposed at intervals on the second axial side of the bearing 35.

The resolver stator 52 is positioned radially outside the resolver rotor 51. The resolver stator 52 is in an annular shape surrounding the resolver rotor 51. The resolver stator 52 is held by the resolver holding portion 25. Although not illustrated, the resolver stator 52 includes a coil. When the resolver rotor 51 rotates together with the shaft 31, induced voltage corresponding to a circumferential position of the resolver rotor 51 is generated in the coil of the resolver stator 52. The resolver 50 can detect rotation of the resolver rotor 51 and the shaft 31 based on change in the induced voltage generated in the coil of the resolver stator 52. This enables the resolver 50 to detect rotation of the rotor 30.

The electricity removal device 80 is positioned radially inside the peripheral wall portion 23b. The electricity removal device 80 is in an annular shape surrounding the shaft 31. In the present embodiment, the electricity removal device 80 has an annular shape about the central axis J. The electricity removal device 80 surrounds the second shaft member 110. More specifically, the electricity removal device 80 surrounds the end portion on the first axial side (−Y side) of the contacted tube portion 113, that is, the opening end portion 110a. In the present embodiment, the electricity removal device 80 is fitted to the radially inner side of the second wall portion 23d.

The electricity removal device 80 is positioned on the first axial side (−Y side) of the bearing 35. Due to this, the bearing 35 is positioned axially between the resolver rotor 51 and the electricity removal device 80. The electricity removal device 80 and the bearing 35 are spaced apart from each other in the axial direction. That is, the bearing 35 is positioned away from the second axial side (+Y side) of the electricity removal device 80. As illustrated in FIGS. 3 and 4, the electricity removal device 80 includes a base portion 81 in an annular shape about the central axis J, and the brush portion 82 provided over the entire circumference of a radially inner edge portion of the base portion 81.

As illustrated in FIG. 2, the base portion 81 is fitted to the radially inner side of the second wall portion 23d. The base portion 81 is fixed to the second wall portion 23d with an adhesive, for example. Due to this, the electricity removal device 80 is fixed to the motor housing 20. A method for fixing the electricity removal device 80 to the motor housing 20 is not particularly limited. The electricity removal device 80 may be fixed to the motor housing 20 by press fitting, for example.

A surface of the base portion 81 on the first axial side (−Y side) in a radially outer edge portion is in contact with the first stepped surface 24c. Due to this, the electricity removal device 80 is in contact with the first stepped surface 24c. Thus, the electricity removal device 80 can be suitably positioned axially with respect to the motor housing 20. The base portion 81 is in electrical contact with the peripheral wall portion 23b. Due to this, the electricity removal device 80 is in electrical contact with the motor housing 20. In the present description, “an object is in electrical contact with another object” is sufficient if electric current can flow between the object and the other object.

The brush portion 82 is in an annular shape surrounding the shaft 31. More specifically, the brush portion 82 has an annular shape about the central axis J and surrounding the contacted tube portion 113. In the present embodiment, the brush portion 82 is composed of a plurality of conductive fibers protruding radially inward from the radially inner edge portion of the base portion 81. The fibers constituting the brush portion 82 are, for example, microfibers. The brush portion 82 is electrically connected to the base portion 81. The radially inner edge portion of the brush portion 82 is in electrical contact with the outer peripheral surface of the contacted tube portion 113. Due to this, the electricity removal device 80 is in electrical contact with the shaft 31. In the present embodiment, the shaft 31 rotates while the outer peripheral surface of the contacted tube portion 113 is rubbed against the radially inner edge portion of the brush portion 82.

In this way, the shaft 31 and the motor housing 20 are electrically communicated with each other through the electricity removal device 80. Therefore, it is possible to flow a current generated in the shaft 31 from the peripheral wall portion 23b to the motor housing 20 through the brush portion 82 and the base portion 81 in this order. This makes it possible to suppress the current from flowing from the shaft 31 to the bearings 34 and 35 that rotatably support the shaft 31. Therefore, electrolytic corrosion can be prevented from occurring in the bearings 34 and 35.

The nozzle member 70 is a member for supplying the oil O as a fluid to the inside of the shaft 31. The nozzle member 70 is made by metallic molding, for example, injection molding or die casting. The nozzle member 70 is disposed inside the peripheral wall portion 23b. The nozzle member 70 is disposed to oppose the second axial side (+Y side) of the bottom wall portion 23a. At least a part of the nozzle member 70 is inserted into the second shaft member 110 from the opening end portion 110a. In the present embodiment, a part of the nozzle member 70 is inserted into the second shaft member 110. The nozzle member 70 includes a supply tube portion 71, a guide tube portion 72, a nozzle flange portion 73, and an outer tube portion 75.

The supply tube portion 71 extends in the axial direction. In the present embodiment, the supply tube portion 71 is in a cylindrical shape about the central axis J. The supply tube portion 71 is open on the second axial side (+Y side). The supply tube portion 71 is open on the inside of the shaft 31. In the present embodiment, the entire supply tube portion 71 is positioned inside the second shaft member 110. More specifically, the entire supply tube portion 71 except for the end portion on the second axial side is positioned inside the contacted tube portion 113. The end portion on the second axial side of the supply tube portion 71 is positioned inside the fit tube portion 111. The end portion on the second axial side of the supply tube portion 71 is positioned on the first axial side (−Y side) relative to the connection channel portion 115. The supply tube portion 71 is disposed radially inward away from the inner peripheral surface of the second shaft member 110.

The guide tube portion 72 communicates with the first axial side (−Y side) of the supply tube portion 71. The guide tube portion 72 has a cylindrical shape that opens on the first axial side about the central axis J. The inner diameter and the outer diameter of the guide tube portion 72 increase toward the first axial side. The guide tube portion 72 is a truncated cone-shaped tube whose inner diameter and outer diameter increase toward the first axial side. The outer diameter at the end portion on the second axial side (+Y side) of the guide tube portion 72 is the same as the outer diameter at the end portion on the first axial side of the supply tube portion 71, and is smaller than the inner diameter of the second shaft member 110. The inner diameter at the end portion on the second axial side of the guide tube portion 72 is the same as the inner diameter at the end portion on the first axial side of the supply tube portion 71. The outer diameter at the end portion on the first axial side of the guide tube portion 72 is larger than the inner diameter of the second shaft member 110 at the opening end portion 110a.

The portion on the second axial side (+Y side) of the guide tube portion 72 is positioned inside the contacted tube portion 113. The portion on the first axial side (−Y side) of the guide tube portion 72 is positioned outside the second shaft member 110. The guide tube portion 72 is disposed away on the second axial side of the bottom wall portion 23a. The guide tube portion 72 opposes the recess portion 23g in the axial direction. In the present embodiment, an end portion on the first axial side (−Y side) of the guide tube portion 72 is positioned on the radial outside relative to the inner peripheral surface of the opening end portion 110a and is positioned on the radial inside relative to the outer peripheral surface of the opening end portion 110a. The end portion on the first axial side of the guide tube portion 72 is disposed away from the opening end portion 110a on the first axial side. The axial dimension of the guide tube portion 72 is larger than the axial dimension of the supply tube portion 71.

As illustrated in FIGS. 3 and 4, the nozzle flange portion 73 protrudes radially outward from the guide tube portion 72. In the present embodiment, the nozzle flange portion 73 protrudes radially outward from the end portion on the first axial side (−Y side) of the guide tube portion 72. The nozzle flange portion 73 has an annular shape surrounding the central axis J. In the present embodiment, the nozzle flange portion 73 has an annular shape about the central axis J.

As illustrated in FIG. 2, the nozzle flange portion 73 is positioned axially between the electricity removal device 80 and the bottom wall portion 23a. Due to this, the electricity removal device 80 is positioned axially between the bearing 35 and the nozzle flange portion 73. The nozzle flange portion 73 is disposed to oppose the second axial side (+Y side) of the bottom wall portion 23a. The nozzle flange portion 73 is disposed to oppose first axial side (−Y side) of the electricity removal device 80. The nozzle flange portion 73 has an annular portion 73a and a tubular portion 73b.

The annular portion 73a is a portion of the nozzle flange portion 73 that protrudes radially outward from the guide tube portion 72. The annular portion 73a has an annular shape about the central axis J. The annular portion 73a has a plate shape whose plate surface faces the axial direction. In the example of FIG. 2, the surface on the first axial side (−Y side) in a radially outer portion of the annular portion 73a is in contact with a radially outer edge portion of the surface on the second axial side (+Y side) of the bottom wall portion 23a. The radially outer edge portion of the surface on the second axial side of the bottom wall portion 23a is a peripheral edge portion of the recess portion 23g of the surface on the second axial side of the bottom wall portion 23a.

The tubular portion 73b protrudes from the radially outer edge portion of the annular portion 73a to the second axial side (+Y side). The tubular portion 73b has a cylindrical shape about the central axis J. The tubular portion 73b is fitted with a gap on the radially inner side of the first wall portion 23c. Due to this, in the present embodiment, the nozzle flange portion 73 is fitted inside of the peripheral wall portion 23b. Thus, the nozzle member 70 can be positioned radially with respect to the motor housing 20. In the present embodiment, since the tubular portion 73b protruding in the axial direction from the radially outer edge portion of the annular portion 73a is provided, the nozzle member 70 can be more suitably positioned radially with respect to the motor housing 20 by fitting the tubular portion 73b inside of the peripheral wall portion 23b.

The end portion on the second axial side (+Y side) of the tubular portion 73b is positioned on the first axial side (−Y side) relative to the opening end portion 110a. The tubular portion 73b is disposed to oppose the electricity removal device 80 in the axial direction. In the example of FIG. 2, the end portion on the second axial side of the tubular portion 73b is disposed away from the base portion 81 on the first axial side. The nozzle member 70 is axially movable within a range where the tubular portion 73b is movable axially between the electricity removal device 80 and the bottom wall portion 23a, for example.

As illustrated in FIG. 3, the outer tube portion 75 has a cylindrical shape that opens on the second axial side (+Y side) about the central axis J. The outer tube portion 75 extends from the guide tube portion 72 to the second axial side. An end portion on the first axial side (−Y side) of the outer tube portion 75 communicates with a central portion in the axial direction and the radial direction of the guide tube portion 72. The end portion on the second axial side of the outer tube portion 75 is positioned on the second axial side relative to the end portion on the second axial side of the supply tube portion 71. That is, the end portion on the second axial side of the supply tube portion 71 is positioned on the first axial side relative to the end portion on the second axial side of the outer tube portion 75. The outer tube portion 75 is positioned away on the radially outside of the supply tube portion 71. That is, the supply tube portion 71 is positioned away on the radially inside of the outer tube portion 75. The outer tube portion 75 surrounds the supply tube portion 71.

As illustrated in FIG. 2, the outer tube portion 75 is inserted into the second shaft member 110 from the opening end portion 110a. The entire outer tube portion 75 except for the end portion on the first axial side (−Y side) is positioned inside the second shaft member 110. The outer tube portion 75 is disposed radially inward away from the inner peripheral surface of the second shaft member 110. A portion on the first axial side of the outer tube portion 75 is positioned on the radially inside of the contacted tube portion 113 except for the end portion on the first axial side. A portion on the second axial side (+Y side) of the outer tube portion 75 is positioned on the radially inside of the fit tube portion 111.

The radial gap between the portion on the second axial side (+Y side) of the outer tube portion 75 and the fit tube portion 111 is smaller than the radial gap between the portion on the first axial side (−Y side) of the outer tube portion 75 and the contacted tube portion 113. The radial gap between the outer tube portion 75 and the second shaft member 110 is smaller than the radial gap between the outer tube portion 75 and the supply tube portion 71. The outer peripheral surface of the portion on the second axial side of the outer tube portion 75 is positioned away on the radially inside of the cylindrical surface 111b of the inner peripheral surface 111a. The end portion on the second axial side of the outer tube portion 75 is positioned on the first axial side relative to the end portion on the second axial side of the second shaft member 110. The end portion on the second axial side of the outer tube portion 75 is positioned on the first axial side relative to the first inclined surface 111c.

The cover member 120 is a member that covers at least a part of the electricity removal device 80. In the present embodiment, the cover member 120 covers substantially the entire electricity removal device 80 from the second axial side (+Y side). The cover member 120 is positioned inside the peripheral wall portion 23b. More specifically, the cover member 120 is positioned radially inside the second wall portion 23d. The cover member 120 is positioned axially between the bearing 35 and the electricity removal device 80. The cover member 120 is in contact with the bearing 35 in the axial direction. The cover member 120 opposes the electricity removal device 80 in the axial direction with a gap interposed therebetween. Since the cover member 120 is positioned on the second axial side of the electricity removal device 80, even if the fixing of the electricity removal device 80 with respect to the motor housing 20 is released, the electricity removal device 80 can be suppressed from moving to the second axial side.

As illustrated in FIGS. 3 and 4, the cover member 120 is an annular shaped member about the central axis J. The cover member 120 has a plate shape whose plate surface faces the axial direction. As illustrated in FIG. 2, the cover member 120 has an annular shape surrounding the shaft 31. In the present embodiment, the cover member 120 surrounds the second shaft member 110. The cover member 120 includes a body portion 121, a third opposing portion 122, and the guide wall portion 123.

The body portion 121 has an annular shape about the central axis J and has a plate shape whose plate surface faces the axial direction. The body portion 121 is fitted to the radially inner side of the peripheral wall portion 23b. More specifically, the body portion 121 is press-fitted radially inside of the second wall portion 23d. Due to this, the cover member 120 is fixed to the motor housing 20. The surface on the second axial side (+Y side) of the body portion 121 has a first surface 121a and a second surface 121b. As illustrated in FIG. 3, the first surface 121a and the second surface 121b are annular shaped surfaces facing the second axial side about the central axis J. In the present embodiment, the first surface 121a and the second surface 121b are orthogonal to the axial direction.

The first surface 121a is a radially inner portion of the surface on the second axial side (+Y side) of the body portion 121. The second surface 121b is a radially outer portion of the surface on the second axial side of the body portion 121. The second surface 121b communicates with the radially outside of the first surface 121a via a step. The second surface 121b is positioned on the second axial side relative to the first surface 121a. When viewed axially, the second surface 121b surrounds the first surface 121a.

As illustrated in FIG. 2, the end portion of the radially inside of the body portion 121 is a second opposing portion 121c positioned radially outside the first opposing portion 112a. That is, the cover member 120 has the second opposing portion 121c. The second opposing portion 121c is disposed to oppose the first opposing portion 112a with a gap in the radial direction. In the present embodiment, the end portion on the second axial side (+Y side) of the second opposing portion 121c is positioned radially outside the first opposing portion 112a, and is disposed to oppose the first opposing portion 112a with a gap in the radial direction.

As illustrated in FIG. 4, the third opposing portion 122 has an annular shape about the central axis J. The third opposing portion 122 communicates with a radially inner end portion of the body portion 121. More specifically, as illustrated in FIG. 2, the third opposing portion 122 communicates with the surface on the first axial side (−Y side) at the radially inner end portion of the body portion 121. The third opposing portion 122 protrudes on the first axial side and radially inward from the body portion 121. The surface on the second axial side (+Y side) in the portion of the third opposing portion 122 protruding radially inward relative to the body portion 121 is positioned on the first axial side relative to the first surface 121a.

The radially inner end portion of the third opposing portion 122 is the radially inner end portion of the cover member 120. The radially inner end portion of the third opposing portion 122 is positioned radially outside the outer peripheral surface of the contacted tube portion 113. The radially inner end portion of the third opposing portion 122 radially opposes the outer peripheral surface of the contacted tube portion 113 with a gap interposed therebetween. The third opposing portion 122 is positioned on the first axial side (−Y side) of the first opposing portion 112a. The third opposing portion 122 is disposed to oppose the first opposing portion 112a with a gap interposed therebetween in the axial direction.

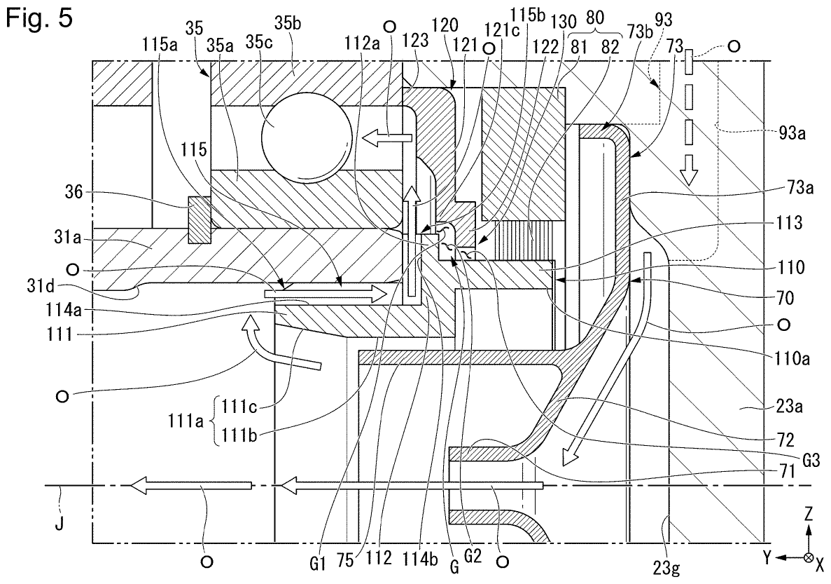

In the present embodiment, a labyrinth seal structure 130 is configured by the first opposing portion 112a, the second opposing portion 121c, the third opposing portion 122, and a portion of the contacted tube portion 113 radially opposing the cover member 120. The labyrinth seal structure 130 is provided between the second shaft member 110 and the cover member 120. As illustrated in FIG. 5, a gap G between the second shaft member 110 and the cover member 120 in the labyrinth seal structure 130 is open on both axial sides. An opening on the first axial side (−Y side) in the gap G is positioned on the radial inside relative to an opening on the second axial side (+Y side) in the gap G.

The gap G includes a first gap portion G1, a second gap portion G2, and a third gap portion G3. The first gap portion G1 has an opening on the second axial side (+Y side) in the gap G. The first gap portion G1 extends in the axial direction. The second gap portion G2 extends radially inward from an end portion on the first axial side (−Y side) of the first gap portion G1. The third gap portion G3 extends from an end portion of the radially inside of the second gap portion G2 to the first axial side. The third gap portion G3 has an opening on the first axial side in the gap G.

The guide wall portion 123 protrudes from the body portion 121 to the second axial side (+Y side). In the present embodiment, the guide wall portion 123 protrudes from the radially outer edge portion of the body portion 121 to the second axial side. More specifically, the guide wall portion 123 protrudes from the radially outer edge portion of the second surface 121b to the second axial side. The guide wall portion 123 is disposed to oppose the bearing 35 in the axial direction. More specifically, the guide wall portion 123 is disposed to oppose the outer ring 35b of the bearing 35 in the axial direction. The guide wall portion 123 is positioned on the first axial side (−Y side) of the bearing 35. The radial position on the inner peripheral surface of the guide wall portion 123 is, for example, the same as the radial position on the inner peripheral surface of the outer ring 35b of the bearing 35. In the example of FIG. 2, the guide wall portion 123 is in contact with the outer ring 35b of the bearing 35 in the axial direction.

As illustrated in FIG. 3, the guide wall portion 123 extends in the circumferential direction. In the present embodiment, the guide wall portion 123 has an annular shape about the central axis J. As illustrated in FIG. 2, guide wall portion 123 is positioned radially outside the second opening portion 115b of the connection channel portion 115. The guide wall portion 123 is disposed to oppose the second opening portion 115b with a gap interposed therebetween. The guide wall portion 123 overlaps the second opening portion 115b in the radial direction. In other words, the guide wall portion 123 overlaps the second opening portion 115b when viewed in the radial direction.

As illustrated in FIG. 1, the drive device 100 in the present embodiment is provided with the refrigerant channel portion 90 through which the oil O as a refrigerant circulates. The refrigerant channel portion 90 is provided across the inside of the motor housing 20 and the inside of the gear housing 61. The refrigerant channel portion 90 is a channel through which the oil O stored in the gear housing 61 is supplied to the rotating electrical machine 10 and returns to the inside of the gear housing 61 again. The refrigerant channel portion 90 is provided with a pump 96, a cooler 97, and the refrigerant supply portion 95. In the following description, an upstream side in a flow direction of the oil O in the refrigerant channel portion 90 is simply referred to as “upstream side”, and a downstream side in the flow direction of the oil O in the refrigerant channel portion 90 is simply referred to as “downstream side”. The refrigerant channel portion 90 includes a gear-side channel portion 91, an intermediate channel portion 92, and a rotating electrical machine-side channel portion 93.

The gear-side channel portion 91 includes a first portion 91a and a second portion 91b. The first portion 91a and the second portion 91b are provided in a wall portion of the gear housing 61, for example. The first portion 91a allows a portion inside the gear housing 61 where the oil O stored and the pump 96 to communicate with each other. The second portion 91b allows the pump 96 and the cooler 97 to communicate with each other.

The intermediate channel portion 92 is provided across the wall portion of the gear housing 61 and a wall portion of the motor housing 20. The intermediate channel portion 92 allows the gear-side channel portion 91 and the rotating electrical machine-side channel portion 93 to communicate with each other. More specifically, the intermediate channel portion 92 allows the cooler 97 and a third channel portion 93c described later to communicate with each other.

The rotating electrical machine-side channel portion 93 is provided in the rotating electrical machine 10. The rotating electrical machine-side channel portion 93 includes a first channel portion 93a, a second channel portion 93b, and the third channel portion 93c. That is, the rotating electrical machine 10 includes the first channel portion 93a, the second channel portion 93b, and the third channel portion 93c. The first channel portion 93a and the third channel portion 93c are provided in the wall portion of the motor housing 20. The second channel portion 93b includes a housing channel portion 93d provided on the wall portion of the motor housing 20, and the refrigerant supply portion 95. In the present embodiment, the first channel portion 93a, the third channel portion 93c, and the housing channel portion 93d are provided in the lid portion 23. The third channel portion 93c communicates with the first channel portion 93a and the second channel portion 93b. In the present embodiment, the first channel portion 93a and the second channel portion 93b branch from the third channel portion 93c.

The first channel portion 93a is a channel portion through which the oil O as a fluid to is supplied to inside the peripheral wall portion 23b. The first channel portion 93a has an end portion on the upstream side that communicates with an end portion of the third channel portion 93c on the downstream side. The first channel portion 93a has an end portion on the downstream side that opens to the inside of the peripheral wall portion 23b. As illustrated in FIG. 2, an end portion on the downstream side of the first channel portion 93a is open to the surface on the second axial side (+Y side) of the bottom wall portion 23a. In the present embodiment, the end portion on the downstream side of the first channel portion 93a is open to the inside of the recess portion 23g.

As illustrated in FIG. 1, the second channel portion 93b is a channel portion through which the oil O as a fluid is supplied to the stator 40. An end portion of the second channel portion 93b on the upstream side of the housing channel portion 93d communicates with an end portion of the third channel portion 93c on the downstream side. The housing channel portion 93d has an end portion on the downstream side that communicates with an end portion of the refrigerant supply portion 95 on the upstream side.

In the present embodiment, the refrigerant supply portion 95 is in a tubular shape extending axially. In other words, in the present embodiment, the refrigerant supply portion 95 is an axially extending pipe. The refrigerant supply portion 95 has axially both end portions supported by the motor housing 20. The refrigerant supply portion 95 has the end portion on the second axial side (+Y side) that is supported by the partition wall portion 22, for example. The refrigerant supply portion 95 has the end portion on the first axial side (−Y side) that is supported by the lid portion 23, for example.

The refrigerant supply portion 95 is positioned radially outside the stator 40. In the present embodiment, the refrigerant supply portion 95 is positioned on the upper side of the stator 40. In the present embodiment, an orientation in which the oil O in the refrigerant supply portion 95 flows is an orientation of flowing from the first axial side to the second axial side. That is, in the flow direction of the oil O in the refrigerant supply portion 95, the first axial side is an upstream side and the second axial side is a downstream side. The refrigerant supply portion 95 has a supply port 95a for supplying the oil O as a refrigerant to the stator 40. In the present embodiment, the supply port 95a is an injection port through which the oil O having flowed into the refrigerant supply portion 95 is injected partially to the outside of the refrigerant supply portion 95. A plurality of supply ports 95a are provided.

When the pump 96 is driven, the oil O stored in the gear housing 61 is sucked up through the first portion 91a and flows into the cooler 97 through the second portion 91b. The oil O having flowed into the cooler 97 is cooled in the cooler 97, and then flows from the third channel portion 93c into the rotating electrical machine-side channel portion 93 through the intermediate channel portion 92. The oil O having flowed into the third channel portion 93c branches into the first channel portion 93a and the second channel portion 93b. As illustrated in FIG. 5, the oil O having flowed into the first channel portion 93a flows into the peripheral wall portion 23b. In the present embodiment, the oil O from the first channel portion 93a flows into the recess portion 23g provided in the bottom wall portion 23a. The oil O from the first channel portion 93a flows into a gap in the axial direction between the nozzle flange portion 73 and the bottom wall portion 23a.

The oil O having flowed into the peripheral wall portion 23b flows into the shaft 31 through inside the nozzle member 70. More specifically, the oil O having flowed into the peripheral wall portion 23b flows into the second shaft member 110 through inside the guide tube portion 72 and inside the supply tube portion 71 in this order. As described above, in the present embodiment, providing the first channel portion 93a enables the oil O to be supplied from the inside of the peripheral wall portion 23b into the shaft 31. The oil O having flowed into the second shaft member 110 flows into the first shaft member 31a. A part of the oil O having flowed into the first shaft member 31a flows to the second axial side (+Y side) through inside the first shaft member 31a. As illustrated in FIG. 1, the oil O having flowed into the shaft 31 from the nozzle member 70 and flowing to the second axial side through inside the first shaft member 31a passes through the inside of the rotor body 32 from the hole portion 33 and scatters to the stator 40.

As illustrated in FIG. 2, another part of the oil O having flowed into the first shaft member 31a flows out of the shaft 31 through the connection channel portion 115. Another part of the oil O having flowed into the first shaft member 31a flows to the first axial side (−Y side) by being pressed against the inner peripheral surface of the first shaft member 31a by a centrifugal force generated by the rotation of the rotor 30, for example, and flows into the connection channel portion 115 from the first opening portion 115a. The oil O having flowed into the connection channel portion 115 flows to the first axial side inside the first groove 114a, then flows radially outward inside the second groove 114b, and is discharged from the second opening portion 115b to the outside of the connection channel portion 115. The oil O discharged from the second opening portion 115b to the outside of the connection channel portion 115 flows radially outward axially between the bearing 35 and the cover member 120, and is supplied between the inner ring 35a and the outer ring 35b of the bearing 35. At least a part of the oil O flowing out of the connection channel portion 115 from the second opening portion 115b is guided to the second axial side (+Y side) along the guide wall portion 123 and supplied to the bearing 35. As illustrated in FIG. 3, at least a part of the oil O in contact with the guide wall portion 123 flows to the lower side along the guide wall portion 123 by gravity.

As illustrated in FIG. 1, the oil O having flowed into the second channel portion 93b flows inside of the refrigerant supply portion 95 through the housing channel portion 93d. The oil O having flowed into the refrigerant supply portion 95 is injected from the supply port 95a and supplied to the stator 40. Thus, by providing the first channel portion 93a and the second channel portion 93b, which branch from the third channel portion 93c, it is possible to suitably and easily supply the oil O sent from the inside of the gear housing 61 into the shaft 31 through the inside of the peripheral wall portion 23b and to the stator 40 from the refrigerant supply portion 95.

In the present embodiment, the oil O scraped up by the ring gear 63a partially enters a reservoir 98 provided in the gear housing 61. The oil O having entered the reservoir 98 flows into the shaft 31 from an end portion on the second axial side (+Y side). The oil O having flowed into the shaft 31 from the reservoir 98 passes through the inside of the rotor body 32 from the hole portion 33 and scatters to the stator 40.

The oil O supplied to the stator 40 from the supply port 95a and the oil O supplied to the stator 40 from the inside of the shaft 31 take heat from the stator 40. The oil O having cooled the stator 40 falls to the lower side to accumulate in a lower region in the motor housing 20. The oil O accumulated in the lower region in the motor housing 20 returns to the inside of the gear housing 61 through the partition wall opening 22a provided in the partition wall portion 22. As described above, the refrigerant channel portion 90 allows the oil O stored in the gear housing 61 to be supplied to the rotor 30 and the stator 40.

According to the present embodiment, the cover member 120 that covers at least a part of the electricity removal device 80 is provided. The cover member 120 is positioned axially between the bearing 35 and the electricity removal device 80. The connection channel portion 115 that allows the inside of the shaft 31 and the outside of the shaft 31 to communicate with each other is provided. The connection channel portion 115 is open in a portion positioned on the second axial side (+Y side) relative to the cover member 120 inside the peripheral wall portion 23b. Therefore, the cover member 120 can suppress the oil O having flowed from the connection channel portion 115 into the peripheral wall portion 23b from flowing toward the electricity removal device 80. This can suppress the oil O from reaching the electricity removal device 80, and the electrical conductivity of the electricity removal device 80 from being lowered by the oil O. Therefore, it is possible to suppress the current generated in the shaft 31 from becoming hard to flow to the motor housing 20 via the electricity removal device 80. That is, it is possible to suppress the electricity removal performance of the electricity removal device 80 from deteriorating. Therefore, for example, the electricity removal device 80 does not need to be an electricity removal device excellent in oil resistance, and the electricity removal device 80 can be easily made a relatively inexpensive electricity removal device. The oil O having flowed from the connection channel portion 115 into the peripheral wall portion 23b can be supplied to the bearing 35 as lubricating oil. As described above, according to the present embodiment, the oil O can be suitably supplied to the bearing 35 while suppressing the deterioration of the electricity removal performance of the electricity removal device 80 due to the oil O.

Here, in the present embodiment, the bearing 35 is a ceramic ball bearing. Ceramic ball bearings often have a structure in which grease cannot be enclosed inside. Therefore, when the bearing 35 is a ceramic ball bearing as in the present embodiment, it is particularly important that the oil O can be supplied as lubricating oil from the outside of the bearing 35. When the bearing 35 is a ceramic ball bearing, it is possible to suppress the current generated in the shaft 31 from flowing to the bearing 35. Therefore, it is possible to suppress generation of a circulating current circulating through the shaft 31, the bearing 35, and the motor housing 20.

The electricity removal device 80 may be the electricity removal device 80 having excellent oil resistance, or may be an electricity removal device having relatively poor oil resistance. “The electricity removal device 80 has excellent oil resistance” means that a change caused by the electricity removal device 80 coming into contact with the oil O hardly occurs in the electricity removal device 80. The oil resistance may be evaluated by an immersion test into the oil O. In this case, the oil resistance is evaluated by change in weight and change in strength after immersion for a predetermined time. The evaluation of change in weight includes viewpoints of, for example, corrosion and swelling.

According to the present embodiment, the connection channel portion 115 is open in a portion of an inside of the peripheral wall portion 23b positioned axially between the bearing 35 and the cover member 120. Therefore, the oil O having flowed into the peripheral wall portion 23b is suppressed from flowing to the first axial side (−Y side) by the cover member 120, and flows to the second axial side (+Y side) to be supplied to the bearing 35. Due to this, the oil O can be more easily supplied to the bearing 35.

According to the present embodiment, at least a part of the connection channel portion 115 is provided in the second shaft member 110. Therefore, the second opening portion 115b of the connection channel portion 115 that opens to the outside of the shaft 31 can be easily positioned close to the bearing 35. Due to this, the oil O can be more easily supplied to the bearing 35 by the connection channel portion 115.

According to the present embodiment, at least a part of the inside of the connection channel portion 115 is configured by the inside of the first groove 114a provided on the outer peripheral surface of the fit tube portion 111. The first groove 114a extends in the axial direction and opens on the second axial side (+Y side). Therefore, at least a part of the connection channel portion 115 is provided between the first shaft member 31a and the second shaft member 110 in the radial direction, and a part of the oil O in the shaft 31 can be easily discharged to the outside of the shaft 31 via the connection channel portion 115.

According to the present embodiment, a part of the inside of the connection channel portion 115 is configured by the inside of the second groove 114b provided on the surface on the second axial side (+Y side) of the flange portion 112. The second groove 114b extends radially outward from an end portion on the first axial side (−Y side) of the first groove 114a and opens radially outward. Therefore, the oil O can be discharged radially outward from the connection channel portion 115 to the inside of the peripheral wall portion 23b through the second groove 114b. Due to this, the oil O having flowed from the connection channel portion 115 into the peripheral wall portion 23b can be more easily supplied to the bearing 35 disposed on the radially outside of the shaft 31. Since the oil O having flowed from the connection channel portion 115 into the peripheral wall portion 23b is caused to flow in an orientation away from the radial gap between the cover member 120 and the shaft 31 to the radial outside, the oil O having flowed from the connection channel portion 115 into the peripheral wall portion 23b can be suppressed from flowing into the radial gap between the cover member 120 and the shaft 31. This makes it possible to further suppress the oil O from reaching the electricity removal device 80.

According to the present embodiment, the second shaft member 110 has the first opposing portion 112a disposed to oppose the cover member 120 with a gap interposed therebetween in the axial direction. Therefore, the cover member 120 and the first opposing portion 112a can more preferably prevent the oil O having flowed from the connection channel portion 115 into the peripheral wall portion 23b from flowing into the electricity removal device 80. As the gap G of the labyrinth seal structure 130 of the present embodiment, the gap between the cover member 120 and the second shaft member 110 is easily formed into a complicated shape, and the oil O can be more suitably suppressed from flowing to the electricity removal device 80 through the gap.

According to the present embodiment, the first opposing portion 112a is positioned on the second axial side (+Y side) of the cover member 120. Therefore, the first opposing portion 112a can prevent the oil O having flowed from the connection channel portion 115 into the peripheral wall portion 23b from flowing into the radial gap between the cover member 120 and the shaft 31. Due to this, the oil O having flowed from the connection channel portion 115 into the peripheral wall portion 23b can be more suitably suppressed from flowing to the electricity removal device 80. The axial gap between the first opposing portion 112a and the cover member 120, that is, the radially outer end portion of the second gap portion G2 is disposed on the opposite side of the electricity removal device 80 with the cover member 120 interposed therebetween in the axial direction. Therefore, even if the oil O flows into the second gap portion G2, the oil O having flowed into the second gap portion G2 flows radially outward by centrifugal force, and is easily discharged from the radially outer end portion of the second gap portion G2 to the opposite side of the electricity removal device 80 across the cover member 120. This makes it possible to suppress the oil O more suitably from flowing to the electricity removal device 80 through the second gap portion G2.

According to the present embodiment, the first opposing portion 112a is provided in the flange portion 112. Therefore, the oil O discharged into the peripheral wall portion 23b through the opening portion on the radially outside of the second groove 114b provided in the flange portion 112 easily flows radially outward along the flange portion 112 and is easily separated radially outward from the first opposing portion 112a. This makes it possible to suppress the oil O from flowing into the gap in the axial direction between the first opposing portion 112a and the cover member 120. Therefore, the oil O can be more suitably suppressed from flowing to the electricity removal device 80.

According to the present embodiment, the cover member 120 includes the second opposing portion 121c that opposes the first opposing portion 112a with a gap in the radial direction. Therefore, the gap between the cover member 120 and the second shaft member 110 can be easily formed into a more complicated shape by the first opposing portion 112a and the second opposing portion 121c, and the labyrinth seal structure 130 can be configured as in the present embodiment. Due to this, the labyrinth seal structure 130 can more suitably suppress the oil O from flowing to the electricity removal device 80.

When the labyrinth seal structure 130 is provided between the shaft 31 and the cover member 120 as in the present embodiment, the shape of the shaft 31 tends to be complicated. Therefore, when the first shaft member 31a and the second shaft member 110 are the identical single member, it may be difficult to make the shaft 31. On the other hand, in the present embodiment, since the first shaft member 31a and the second shaft member 110 are separate bodies from each other, the first opposing portion 112a is easily provided with respect to the second shaft member 110, and the labyrinth seal structure 130 is easily made.

According to the present embodiment, the cover member 120 has an annular shape surrounding the shaft 31. Therefore, the oil O that about to flow to the electricity removal device 80 is more suitably blocked by the cover member 120. Due to this, the oil O can be more suitably suppressed from flowing to the electricity removal device 80.

According to the present embodiment, the cover member 120 has the guide wall portion 123 disposed to oppose the bearing 35 in the axial direction. Therefore, the oil O having flowed into the peripheral wall portion 23b from the connection channel portion 115 can be easily guided to the bearing 35 by the guide wall portion 123. The guide wall portion 123 extends in the circumferential direction. Therefore, as indicated by a dashed line in FIG. 3, at least a part of the oil O in contact with the guide wall portion 123 easily flows in the circumferential direction along the guide wall portion 123. Due to this, the oil O can be easily supplied to the bearing 35 in a relatively wide range in the circumferential direction. Therefore, the oil O can be more suitably supplied to the bearing 35. When the shaft 31 extends in the horizontal direction as in the present embodiment, at least a part of the oil O in contact with the guide wall portion 123 easily flows to a lower side along the guide wall portion 123 using gravity. Due to this, the oil O can be easily flown in the circumferential direction along the guide wall portion 123, and the oil O can be more suitably supplied to the bearing 35.

According to the present embodiment, the connection channel portion 115 is open toward the guide wall portion 123. Therefore, the oil O discharged from the connection channel portion 115 into the peripheral wall portion 23b can be easily brought into contact with the guide wall portion 123. Due to this, the oil O is more easily guided to the bearing 35 by the guide wall portion 123.

According to the present embodiment, the inner peripheral surface of the second shaft member 110 has the first inclined surface 111c positioned radially outward toward the second axial side (+Y side). Therefore, in the second shaft member 110, the oil O pressed against the first inclined surface 111c by the centrifugal force easily flows to the second axial side, that is, the side on which the first shaft member 31a is positioned. Due to this, the oil O in the second shaft member 110 can be suppressed from flowing to the opening end portion 110a. Therefore, it is possible to suppress the oil O from flowing out to the outside of the shaft 31 through the opening end portion 110a and reaching the electricity removal device 80. Since the oil O flows to the second axial side along the first inclined surface 111c, the oil O is easily guided to the coupling portion between the first shaft member 31a and the second shaft member 110. Therefore, when the connection channel portion 115 is provided between the first shaft member 31a and the second shaft member 110 as in the present embodiment, the oil O can be easily guided to the connection channel portion 115.

According to the present embodiment, the nozzle member 70 includes the outer tube portion 75 inserted into the second shaft member 110 from the opening end portion 110a, and the supply tube portion 71 positioned away on the radially inside of the outer tube portion 75 and open to the inside of the shaft 31. As described above, by providing the outer tube portion 75 on the radially outside of the supply tube portion 71, it is possible to increase the outer diameter of the portion of the nozzle member 70 to be inserted into the second shaft member 110 while relatively reducing the inner diameter and the outer diameter of the supply tube portion 71. Therefore, while reducing the gap between the second shaft member 110 and the nozzle member 70 to suppress the oil O from flowing to the opening end portion 110a, the inner diameter of the supply tube portion 71 can be reduced to suitably adjust the flow rate of the oil O supplied from the supply tube portion 71 to the shaft 31. As compared with the case where the supply tube portion 71 communicates with the second axial side (+Y side) of the outer tube portion 75, the axial position of the supply tube portion 71 can be set to the first axial side (−Y side). Therefore, the axial position of the supply tube portion 71 can be easily set to the first axial side relative to the first opening portion 115a of the connection channel portion 115. Due to this, the oil O discharged from the supply tube portion 71 to the first axial side can easily flow into the connection channel portion 115 through the first opening portion 115a.

For example, even if the outer diameter of the supply tube portion 71 is made the same in size as the outer diameter of the outer tube portion 75 and the inner diameter of the supply tube portion 71 is made relatively small instead of providing the outer tube portion 75, the flow rate of the oil O supplied from the supply tube portion 71 to the shaft 31 can be suitably adjusted while suppressing the oil O from flowing to the opening end portion 110a. However, in this case, the thickness of the supply tube portion 71 increases, and sink marks and the like are likely to occur when the nozzle member 70 is formed by metallic molding. Therefore, by separately providing the outer tube portion 75, it is possible to suppress the outflow of the oil O from the opening end portion 110a and to suitably adjust the flow rate of the oil O supplied from the supply tube portion 71 to the shaft 31 while easily forming the nozzle member 70 suitably by metallic molding.

According to the present embodiment, the end portion on the second axial side (+Y side) of the supply tube portion 71 is positioned on the first axial side (−Y side) relative to the end portion on the second axial side of the outer tube portion 75 and the connection channel portion 115. Therefore, the oil O discharged from the supply tube portion 71 to the first axial side can more easily flow into the connection channel portion 115.

According to the present embodiment, the radial gap between the outer tube portion 75 and the second shaft member 110 is smaller than the radial gap between the outer tube portion 75 and the supply tube portion 71. Therefore, it is easy to relatively reduce the radial gap between the outer tube portion 75 and the second shaft member 110. This make it possible to further suppress the oil O from flowing to the opening end portion 110a through the radial gap between the outer tube portion 75 and the second shaft member 110. Therefore, it is possible to further suppress the oil O from flowing out from the opening end portion 110a and flowing to the electricity removal device 80.

According to the present embodiment, the inner peripheral surface of the first shaft member 31a has the fourth inclined surface 31d positioned radially outward towards the first axial side (−Y side). The fourth inclined surface 31d is positioned on the second axial side (+Y side) relative to the connection channel portion 115. Therefore, the oil O pressed against the inner peripheral surface of the first shaft member 31a by the centrifugal force easily flows to the first axial side along the fourth inclined surface 31d and is easily guided into the connection channel portion 115.

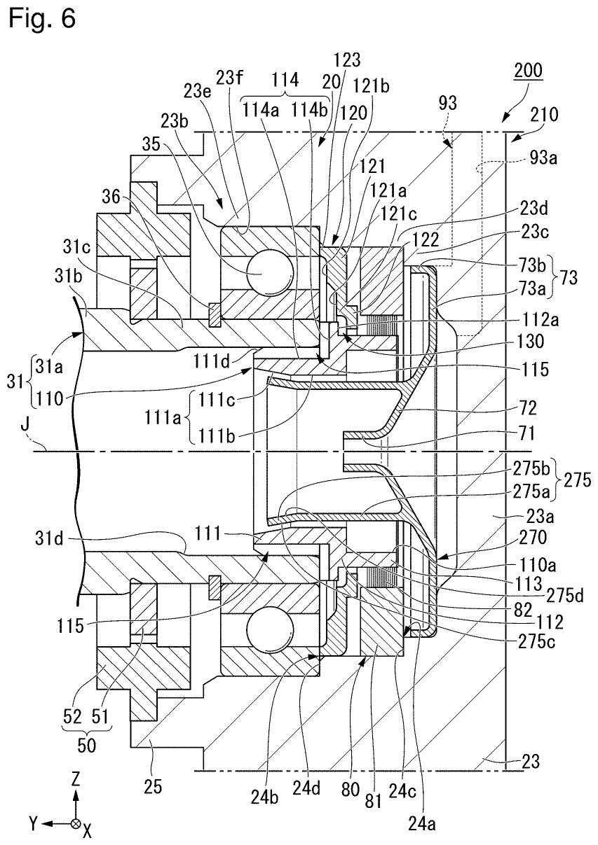

In the following description, configurations similar to those of the above-described embodiment may be denoted by the identical reference numerals as appropriate, and description may be omitted. As illustrated in FIG. 6, in a rotating electrical machine 210 of a drive device 200 of the present embodiment, an outer tube portion 275 of a nozzle member 270 includes an outer tube body portion 275a and an enlarged-diameter portion 275b. The configuration of the outer tube body portion 275a is similar to that of the outer tube portion 75 of the first embodiment.

The enlarged-diameter portion 275b communicates with the second axial side (+Y side) of the outer tube body portion 275a. The enlarged-diameter portion 275b has a cylindrical shape that opens on the second axial side about the central axis J. The inner diameter and the outer diameter of the enlarged-diameter portion 275b increase toward the second axial side. The enlarged-diameter portion 275b is positioned radially inside the first inclined surface 111c except for an end portion on the first axial side (−Y side).

The outer peripheral surface of the enlarged-diameter portion 275b is a second inclined surface 275c radially opposing to the first inclined surface 111c. That is, a portion of the outer peripheral surface of the nozzle member 270 opposing the inner peripheral surface of the second shaft member 110 has the second inclined surface 275c. The second inclined surface 275c is positioned radially outward toward the second axial side (+Y side). Therefore, it is possible to narrow a radial gap between the first inclined surface 111c and the second inclined surface 275c. This makes it possible to further suppress the oil O from flowing from the gap between the nozzle member 270 and the second shaft member 110 to the opening end portion 110a. In the present embodiment, the second inclined surface 275c is a cylindrical surface whose inner diameter increases toward the second axial side about the central axis J. The shape of the second inclined surface 275c is similar to the outer peripheral surface of a truncated cone whose outer diameter increases toward the second axial side. The second inclined surface 275c is a surface along the first inclined surface 111c. In the present embodiment, the angle at which the second inclined surface 275c is inclined with respect to the axial direction is the same as the angle at which the first inclined surface 111c is inclined with respect to the axial direction.

The inner peripheral surface of the enlarged-diameter portion 275b is a third inclined surface 275d positioned radially outward toward the second axial side (+Y side). That is, the inner peripheral surface of the outer tube portion 275 has the third inclined surface 275d. Therefore, in the outer tube portion 275, the oil O pressed against the third inclined surface 275d by the centrifugal force easily flows to the second axial side, that is, the inside of the shaft 31. This makes it possible to cause the oil O in the outer tube portion 275 to suitably flow into the shaft 31. Therefore, the oil O can be suitably supplied into the shaft 31 by the nozzle member 270. In the present embodiment, the third inclined surface 275d is a cylindrical surface whose inner diameter increases toward the second axial side about the central axis J. The shape of the third inclined surface 275d is similar to the outer peripheral surface of a truncated cone whose outer diameter increases toward the second axial side. In the present embodiment, the angle at which the third inclined surface 275d is inclined with respect to the axial direction is the same as the angle at which the second inclined surface 275c is inclined with respect to the axial direction.

Other configurations of each portion of the rotating electrical machine 210 can be made similar to the other configurations of each portion of the rotating electrical machine 10 of the first embodiment. The other configuration of each portion of the drive device 200 can be made similar to the other configuration of each portion of the drive device 100 of the first embodiment.

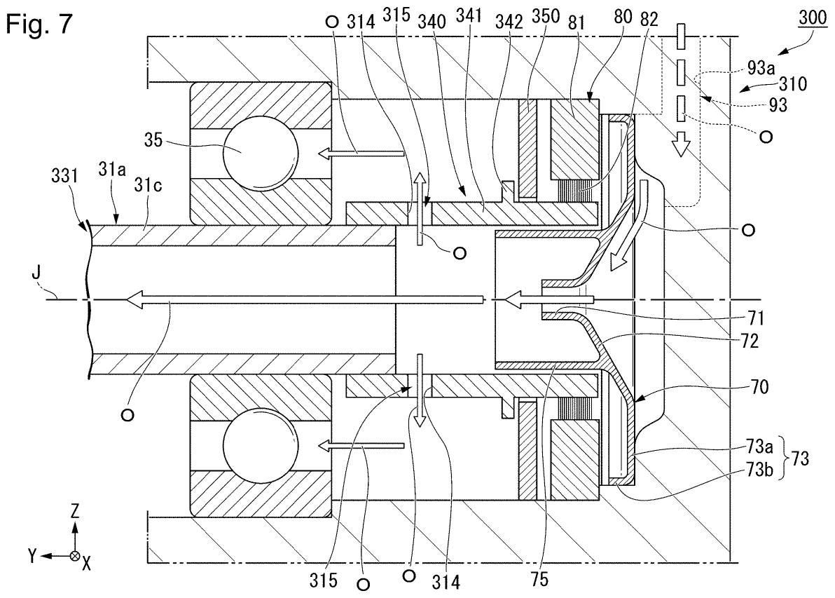

In the following description, configurations similar to those of the above-described embodiments may be denoted by the identical reference numerals as appropriate, and description may be omitted. As illustrated in FIG. 7, in a rotating electrical machine 310 of a drive device 300 of the present embodiment, a second shaft member 340 of a shaft 331 includes a body portion 341 and a first opposing portion 342.

The body portion 341 has a cylindrical shape that opens on both axial sides about the central axis J. An end portion on the first axial side (−Y side) of the first shaft member 31a is press-fitted into an end portion on the second axial side (+Y side) of the body portion 341. The brush portion 82 of the electricity removal device 80 is in contact with the outer peripheral surface of an end portion on the first axial side of the body portion 341.

The body portion 341 has a through hole 314 penetrating the wall portion of the body portion 341 in the radial direction. The through hole 314 is provided in a portion of the body portion 341 positioned on the first axial side (−Y side) relative to the first shaft member 31a and on the second axial side (+Y side) relative to the nozzle member 70. A plurality of through holes 314 are provided at intervals in the circumferential direction. Each of the through holes 314 constitutes a connection channel portion 315 allowing the inside of the shaft 331 and the outside of the shaft 331 to communicate with each other. In the present embodiment, the entire connection channel portion 315 is provided in the second shaft member 340.

The first opposing portion 342 protrudes radially outward from the outer peripheral surface of the body portion 341. The first opposing portion 342 has an annular shape about the central axis J. The first opposing portion 342 is positioned on the first axial side (−Y side) relative to the connection channel portion 315. The first opposing portion 342 is positioned on the second axial side (+Y side) of the radially inner end portion of the cover member 350. Other configurations of the second shaft member 340 can be made similar to the other configurations of the second shaft member 110 of the first embodiment.

The cover member 350 has an annular shape about the central axis J and has a flat plate shape whose plate surface faces the axial direction. Unlike the cover member 120 of the first embodiment, the cover member 350 does not have a portion radially opposing the first opposing portion 342. Other configurations of the cover member 350 can be made similar to the other configurations of the cover member 120 of the first embodiment.

Other configurations of each portion of the rotating electrical machine 310 can be made similar to the other configurations of each portion of the rotating electrical machine 10 of the first embodiment. Other configurations of each portion of the drive device 300 can be made similar to the other configurations of each portion of the drive device 100 of the first embodiment.

The present invention is not limited to the above-described embodiments, and other configurations and other methods can be employed within the scope of the technical idea of the present invention. The electricity removal device may be any type of electricity removal device as long as it is in electrical contact with a shaft and a housing of a rotating electrical machine to allow a current flowing through the shaft to release to the housing. The electricity removal device may be an electricity removal device having a carbon brush.

The cover member covering at least a part of the electricity removal device may have any configuration as long as the cover member is positioned axially between the bearing held in the peripheral wall portion and the electricity removal device. The cover member needs not be annular. A plurality of cover members may be provided at intervals in the circumferential direction. The first opposing portion provided on the second shaft member may be disposed on any side in the axial direction with respect to the cover member as long as the first opposing portion opposes the cover member with a gap in the axial direction.

The nozzle member may have any shape. The outer peripheral surface of the nozzle member may be in contact with the inner peripheral surface of the shaft. Any type of fluid may be used as the fluid supplied into inside the shaft from the nozzle member. The fluid may be an insulating liquid or may be water. When the fluid is water, the surface of the stator may be subjected to an insulation treatment.

The connection channel portion allowing the inside of the shaft and the outside of the shaft to communicate with each other may have any configuration as long as the connection channel portion is open in a portion positioned on the second axial side relative to the cover member in the inside of the peripheral wall portion in the housing of the rotating electrical machine. The bearing supplied with the fluid by the connection channel portion may be any type of bearing.

The connection channel portion may have a configuration as a connection channel portion 415 indicated by a double-dashed line in FIG. 2. The connection channel portion 415 is provided in the first shaft member 31a. The connection channel portion 415 is configured by a through hole penetrating the wall portion of the first shaft member 31a in the radial direction. The connection channel portion 415 is open in a portion positioned on the second axial side (+Y side) relative to the bearing 35 of the inside of the peripheral wall portion 23b. The connection channel portion 415 opens in a space axially between resolver 50 and bearing 35. A plurality of the connection channel portions 415 are provided at intervals in the circumferential direction.

The rotating electrical machine applied with the present invention is not limited to a motor, and may be a generator. The use of the rotating electrical machine is not particularly limited. For example, the rotating electrical machine may be equipped on the vehicle for uses other than the use of rotating the axle, or may be equipped on equipment other than a vehicle. The attitude of the rotating electrical machine when used is not particularly limited. The central axis of the rotating electrical machine may extend in the vertical direction. The configurations and methods described above in the present description can be appropriately combined within a range consistent with each other.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotating electrical machine comprising:
a rotor having a hollow shaft rotatable about a central axis;
a stator opposing the rotor with a gap interposed therebetween;
a housing internally accommodating the rotor and the stator;
a bearing rotatably supporting the shaft;
an electricity removal device fixed to the housing and in electrical contact with the shaft and the housing;
a nozzle member that supplies a fluid to an inside of the shaft; and
a cover member that covers at least a part of the electricity removal device, wherein
the shaft includes:
a hollow first shaft member;
a hollow second shaft member that is a separate body from the first shaft member and is coupled to a first axial side of the first shaft member; and
a connection channel portion that allows an inside of the shaft and an outside of the shaft to communicate each other,
the second shaft member has an opening end portion that opens on a first axial side,
at least a part of the nozzle member is inserted into the second shaft member from the opening end portion,
the housing has a peripheral wall portion surrounding the opening end portion,
the bearing is held in the peripheral wall portion and is positioned away on the second axial side of the electricity removal device,
the cover member is positioned axially between the bearing and the electricity removal device, and
the connection channel portion is open in a portion positioned on a second axial side relative to the cover member inside the peripheral wall portion.

2. The rotating electrical machine according to claim 1, wherein the connection channel portion is open in a portion of an inside of the peripheral wall portion positioned axially between the bearing and the cover member.

3. The rotating electrical machine according to claim 1, wherein at least a part of the connection channel portion is provided in the second shaft member.

4. The rotating electrical machine according to claim 3, wherein
the second shaft member includes a fit tube portion fitted inside the first shaft member,
at least a part of an inside of the connection channel portion is configured by an inside of a first groove provided on an outer peripheral surface of the fit tube portion, and
the first groove extends in an axial direction and opens on a second axial side.

5. The rotating electrical machine according to claim 4, wherein
the second shaft member includes a flange portion protruding radially outward from the fit tube portion,
the flange portion is disposed to oppose a first axial side of the first shaft member,
a part of an inside of the connection channel portion is configured by an inside of a second groove provided on a surface on a second axial side of the flange portion, and
the second groove extends radially outward from an end portion on a first axial side of the first groove and opens radially outward.

6. The rotating electrical machine according to claim 5, wherein the flange portion includes a first opposing portion disposed to oppose the cover member with a gap in an axial direction.

7. The rotating electrical machine according to claim 1, wherein the second shaft member includes a first opposing portion disposed to oppose the cover member with a gap in an axial direction.

8. The rotating electrical machine according to claim 6, wherein the first opposing portion is positioned on a second axial side of the cover member.

9. The rotating electrical machine according to claim 6, wherein the cover member includes a second opposing portion that opposes the first opposing portion with a gap in a radial direction.

10. The rotating electrical machine according to claim 1, wherein the cover member has an annular shape surrounding the shaft.

11. The rotating electrical machine according to claim 1, wherein
the cover member includes a guide wall portion disposed to oppose the bearing in an axial direction, and
the guide wall portion extends in a circumferential direction.

12. The rotating electrical machine according to claim 11, wherein the connection channel portion opens toward the guide wall portion.

13. The rotating electrical machine according to claim 1, wherein an inner peripheral surface of the second shaft member includes a first inclined surface positioned radially outward toward a second axial side.

14. The rotating electrical machine according to claim 13, wherein
a portion of an outer peripheral surface of the nozzle member opposing an inner peripheral surface of the second shaft member includes a second inclined surface radially opposing the first inclined surface, and
the second inclined surface is positioned radially outward toward a second axial side.

15. The rotating electrical machine according to claim 1, wherein
the nozzle member includes:
an outer tube portion inserted into the second shaft member from the opening end portion; and
a supply tube portion that is positioned away on a radially inside of the outer tube portion and is open to an inside of the shaft.

16. The rotating electrical machine according to claim 15, wherein
an end portion on a second axial side of the outer tube portion is positioned on a first axial side relative to an end portion on a second axial side of the second shaft member, and
an end portion on a second axial side of the supply tube portion is positioned on a first axial side relative to an end portion on a second axial side of the outer tube portion and the connection channel portion.

17. The rotating electrical machine according to claim 15, wherein a radial gap between the outer tube portion and the second shaft member is smaller than a radial gap between the outer tube portion and the supply tube portion.

18. The rotating electrical machine according to claim 15, wherein an inner peripheral surface of the outer tube portion includes a third inclined surface positioned radially outward toward a second axial side.

19. A drive device comprising:
the rotating electrical machine according to claim 1; and
a gear mechanism connected to the rotating electrical machine.
